(19) United States
(12) Patent Application Publication
(10) Pub. No.: US 2021/0353998 A1
(43) Pub. Date: Nov. 18, 2021

(54) DEVICE FOR MOUNTING A MOBILE PHONE OR TABLET ON AN EXERCISE DEVICE FOR HEAD, HAND AND SHOULDER EXERCISES

(71) Applicant: Trenkle & Trenkle GbR, Pfronten (DE)

(72) Inventor: Kilian TRENKLE, Pfronten (DE)

(73) Assignee: Trenkle & Trenkle GbR, Pfronten (DE)

(21) Appl. No.: 17/321,765

(22) Filed: May 17, 2021

(30) Foreign Application Priority Data
May 18, 2020 (DE) 20 2020 102 802.2

(51) Int. Cl. A63B 23/025; A47B 23/06; A63B 23/16

(52) U.S. Cl. CPC A63B 23/025; A63B 2225/685; A63B 23/16; A47B 23/06

(57) ABSTRACT

A device for mounting a mobile phone or tablet on an exercise device for head, hand and shoulder exercises. In order to permit viewing of teaching and instructional videos during performance of exercises in the upside down position, the device contains a mounting device, which has an inclined front support and an oppositely inclined rear support relative to the front support for mounting the mobile phone or tablet in the two oppositely inclined positions.

### FIELD OF THE DISCLOSURE

The disclosure concerns a device for mounting a mobile phone or tablet on an exercise device for head, hand and shoulder exercises. The disclosure also concerns an exercise device with such a device for mounting a mobile phone or tablet.

### BACKGROUND

An exercise device for head, hand and shoulder exercises is known from DE 20 2012 102 911 U1. It contains a frame consisting of two side parts and crosspieces with a support part arranged on it. The U-shaped support part designed as a cushion support has two side shoulder supports and a center opening for the head. Such an exercise device permits a safe and stable upside down posture for performing various exercises in the upside down position without pressure on the neck and spinal column. Corresponding teaching or instruction videos are offered on the internet for such exercise devices, which can be played on mobile phones or tablets and show exercises and instructions adapted to the device.

### SUMMARY

One aspect of the disclosure relates to a cost-effective, simply produced device for mounting a mobile phone or tablet on an exercise device for head, hand or shoulder exercises and an exercise device with such a device, which also permits viewing the teaching or instructional videos during performance of exercises in an upside down position.

Advantageous embodiments are disclosed herein.

The device according to the disclosure for mounting a mobile phone or tablet on an exercise device for head, hand and shoulder exercises has a holding device with an inclined front support and a rear support inclined opposite the front support for mounting the mobile phone or tablet in two oppositely inclined positions. Because of this, a mobile phone or tablet can be simply moved between a first position for viewing of a video in a sitting position and a second position for viewing of a video in an upside down position. Viewing of teaching or instructional videos during performance of exercises is therefore made possible in a seated and upside down position.

In a particularly simple and expedient implementation, the mounting device can be formed by two holding parts spaced from each other or a single holding element. The two holding parts are simple to produce and can be positioned on a crosspiece of an exercise device adapted to the dimensions of the mobile phone or tablet.

The front support can be formed by two front support surfaces on two separate holding parts or by a single front support surface on the single holding element. The rear support can be formed by two rear support surfaces on the two separate holding parts or a single rear support surface on the single holding element.

The front support surfaces are preferably inclined at an angle a between 40° and 50°, especially at an angle a of 46°, relative to a lower base surface of the holding parts or holding element, whereas the rear support surfaces are inclined at an angle 13 between 65° and 75°, preferably at an angle 13 of 69° relative to a lower base surface of the holding parts or holding element. The front support surfaces and the rear support surfaces, however, can also have the same angle of inclination relative to the base surface.

In another advantageous implementation, the holding parts or the holding element have corresponding extensions on the bottom of their front and rear support surfaces to prevent the mobile phone or tablet from sliding off. The extensions can be designed as nose-like or hook-like projections. To facilitate moving of the mobile phone or tablet between the two positions, the holding parts or the holding element can have an upper rounding between the front and rear support surfaces.

The holding parts or the holding element contain on the bottom a slit-like recess for mounting on an exercise device. The holding parts or the holding element can therefore be positioned simply on the crosspiece of the exercise device.

The two holding parts are preferably designed as two separate components. However, they can also be connected to each other by a bar-like connection element.

The disclosure also concerns an exercise device for head, hand and shoulder exercises with a frame, a support part arranged on the frame and the device just described for mounting a mobile phone or tablet, which is arranged on the frame. The device for mounting the mobile phone or tablet can be designed as a separate component and detachably arranged on the frame. However, it can also be integrated into the frame by a corresponding configuration of a crosspiece of the frame. For example, a crosspiece can already be provided with an integrated mobile phone holder.

### BRIEF DESCRIPTION OF THE DRAWINGS

Additional details and advantages of the disclosure are apparent from the following description of a preferred embodiment example with reference to the drawing. In the drawing:

FIG. 1 shows an exercise device for head, hand and shoulder exercises;

FIG. 2 shows the exercise device of FIG. 1 with a person shown in an upside down position;

FIG. 3 shows a detail view of the exercise device depicted in FIG. 1 with a first embodiment example of the device for mounting of a mobile phone or tablet;

FIG. 4 shows two holding parts of the device depicted in FIG. 3 for mounting a mobile phone or tablet;

FIG. 5 shows the two holding parts depicted in FIG. 4 with a mobile phone in a first mounting position;

FIG. 6 shows the two holding parts depicted in FIG. 4 with a mobile phone in a second mounting position;

FIG. 7 shows a second embodiment example of a device for mounting a mobile phone or tablet on an exercise device depicted in FIG. 1 and

FIG. 8 shows a third embodiment example of a device for mounting a mobile phone or tablet on an exercise device depicted in FIG. 1.

### DETAILED DESCRIPTION

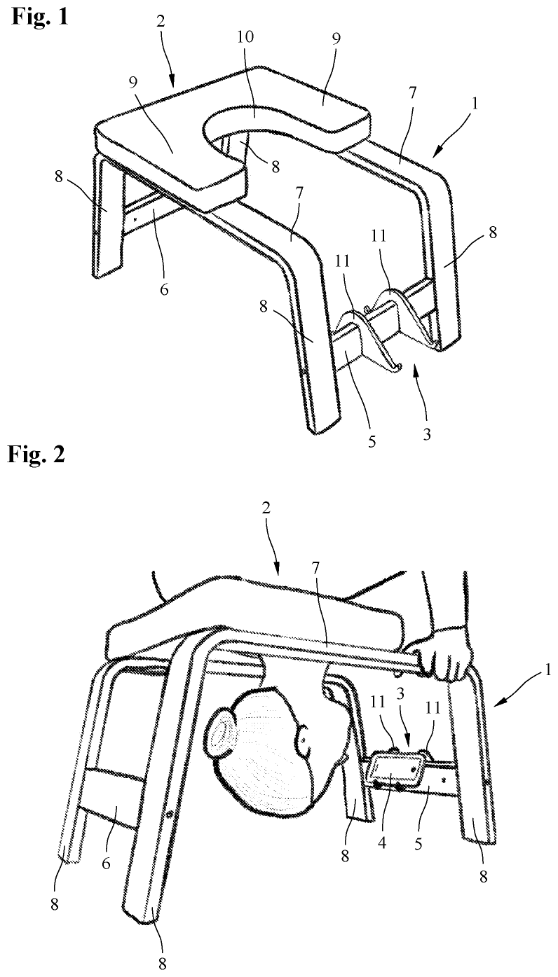

An exercise device for head, hand and shoulder exercises is shown in FIGS. 1 and 2 with a frame 1, a support part 2 designed as a cushion support and a device 3 for mounting a mobile phone or tablet 4 depicted in FIG. 2. Such an exercise device permits a safe and stable upside down posture without pressure on the neck and spinal column. For example, an upside down position schematically shown in FIG. 2 with the head pointing downward can be simply and safely assumed to perform various exercises.

As follows from FIG. 1, the frame 1 in the depicted embodiment consists of two side parts connected to each other via crosspieces 5 and 6, each having the horizontal rail 7 and two downwardly projecting supports or feet 8. In the depicted embodiment example, the two side parts, each with a horizontal rail 7 and two feet 8 inclined slightly forward or rearward are bent from a continuous laminated wooden part and connected to each other via crosspieces 5 and 6. The two side parts are connected to each other via a front crosspiece 5 and a rear crosspiece 6. An additional crosspiece can be provided between the two rails 7 to increase stability.

The support part 2 arranged on the two rails 7 of the frame 1, which is preferably made from a foam provided with a coating, has a U shape with two side support areas 9 for the shoulders and a center opening 10 for the head. Safe and comfortable support for both shoulders is thereby created. The support part 2 is arranged in the area of the rear crosspiece 6 so that the view is directed toward the front crosspiece 5 in the head position schematically depicted in FIG. 2.

The device 3 for mounting a mobile phone or tablet consists of a mounting device that can be placed on the front crosspiece 5 of the exercise device, having an inclined front support for mounting the mobile phone or tablet 4 in a first position, as well as an oppositely inclined rear support for mounting the mobile phone and tablet in a second position.

In the embodiment depicted in FIGS. 1 to 6, the mounting device is formed by two plate-like holding parts 11 that can be mounted at a spacing on the crosspiece 5, which according to FIG. 4 have a triangular shape with a lower base surface 12, a front support surface 13 inclined relative to base surface 12 at an angle α of 46° and a rear support surface 14 inclined opposite the front support surface 13 at an angle β of 69° relative to the horizontal base surface 12.

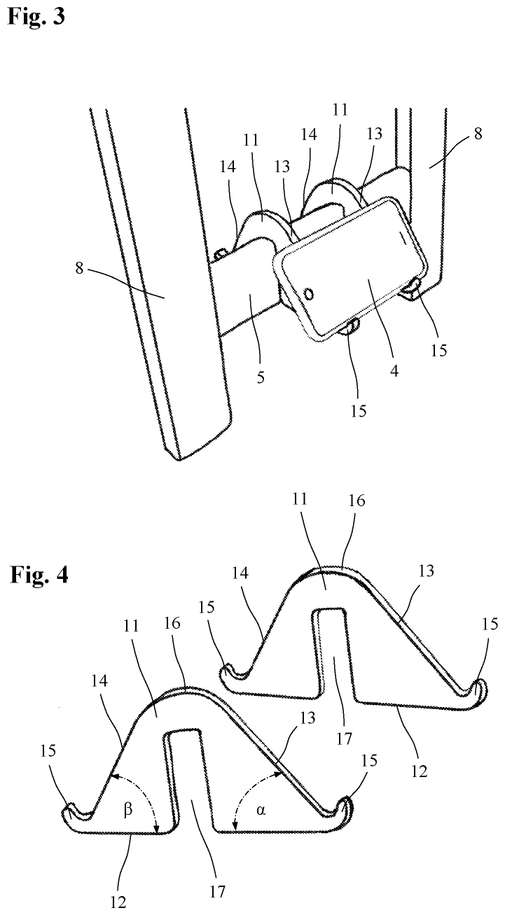

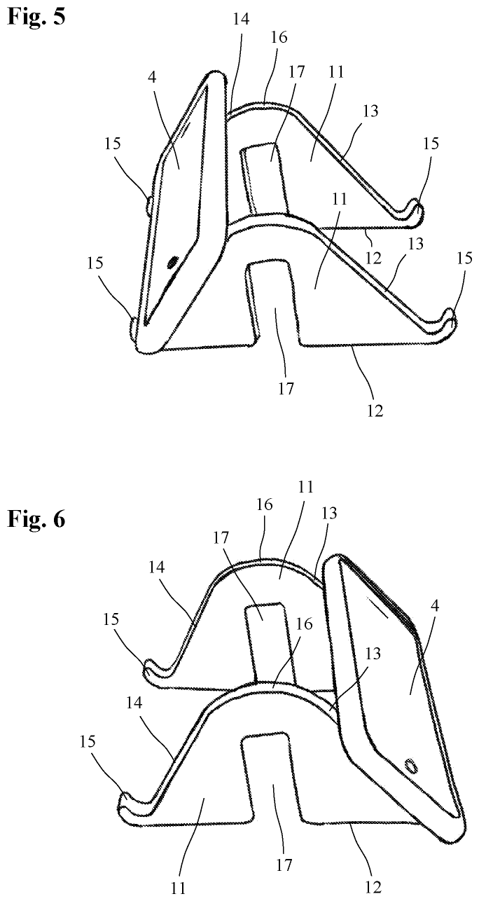

The two holding parts 11 have nose-like or hook-like extensions 15 on the bottom of the two support surfaces 13 and 14 to prevent the mobile phone or tablet 3 [sic; 4] from sliding off. The supports for mounting the mobile phone or tablet 4 in two different positions inclined in different directions are formed by the support surfaces 13 and 14 with the two extensions 15 of the two spaced holding parts 11. The transition between the front support surface 13 and the rear support surface 14 at the vertex of the triangular holding part 11 is provided with a rounding 16 so that the mobile phone or tablet 4 can be moved simply between the position depicted in FIGS. 2 and 5 on the inside of the crosspiece 5 for viewing a video in an upside down position and the position depicted in FIGS. 3 and 6 on the outside of the crosspiece 5 for viewing a video in a position seated in front of the exercise device. Exercise videos can therefore be followed in different positions.

To fasten the two holding parts 11 on the front crosspiece 5, the two identically designed holding parts 11 have a slit-like recess 17 on the bottom designed for mounting on the crosspiece 5. The slit-like recess 17 has a width adapted to the thickness of the crosspiece 5 and is inclined relative to base surface 12 so that the base surface 12 is arranged horizontally when the holding part 11 is positioned on the crosspiece.

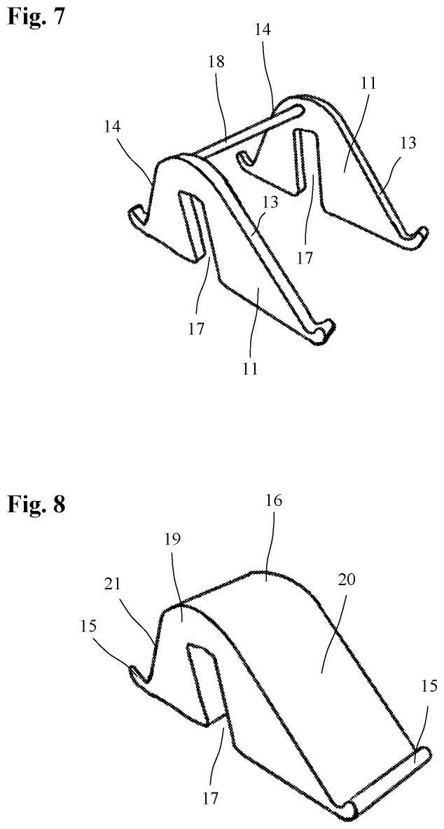

In the device 3 for mounting a mobile phone or tablet 4 depicted in FIGS. 1 to 6, the holding device is formed by the two holding parts 11, which is easily manufactured, for example, from a wooden board by punching or sawing, and which can be easily positioned y on the front crosspiece 5 at a spacing adapted to the corresponding mobile phone or tablet 4. The two holding parts 11, however, can also be connected to each other via a bar-like connection element 18 or another means of connection, as shown in FIG. 7.

However, in another embodiment depicted in FIG. 8, the holding device can also be designed by an individual holding element 19 with a forwardly inclined support surface 20 and an oppositely inclined rear support surface 21 relative to the front support surface 20. As in the previously described embodiment, the holding device designed here in one piece has extensions 15 projecting from the bottom of its front and rear support surfaces 20 and 21 to prevent the mobile phone or tablet from sliding off, as well as an upper rounding 16 between the front and rear support surfaces 20 and 21. The holding element 19 also has a slit-like recess 17 on the bottom for mounting the holding element 19 on a crosspiece 5 of an exercise device depicted in FIG. 1.

1. A device for mounting a mobile phone or tablet on an exercise device for head, hand and shoulder exercises, the device comprising a mounting device, which contains an inclined front support and an oppositely inclined rear support relative to the front support for mounting the mobile phone or tablet in two oppositely inclined positions.

2. The device according to claim 1, wherein the mounting device includes two separate holding parts or a single holding element.

3. The device according to claim 2, wherein the front support is formed by two front support surfaces on the two separate holding parts or a single front support surface on the single holding element.

4. The device according to claim 3, wherein the front support surfaces are inclined at an angle α between 40 and 50° relative to a lower base surface of the holding part or the holding element.

5. The device according to claim 2, wherein the rear support is formed by two rear support surfaces on the two separate holding parts or a single rear support surface on the single holding element.

6. The device according to claim 5, wherein the rear support surfaces are inclined at an angle β between 65 and 75° relative to a lower base surface of the holding parts or the holding element.

7. The device according to claim 2, wherein the holding parts or the holding element have extensions on the bottom of their front and rear support surfaces to prevent the mobile phone and tablet from sliding off

8. The device according to claim 2, wherein the holding parts or the holding element have an upper rounding between the front and rear support surfaces.

9. The device according to claim 2, wherein the holding parts or the holding element contain a recess on the bottom for mounting on an exercise device.

10. The device according to claim 2, wherein the holding parts are connected to each other by a connection element.

11. An exercise device for head, hand and shoulder exercises with a frame and a support part arranged on the frame, wherein the device of claim 1 is arranged on the frame for mounting a mobile phone or tablet.

12. The exercise device according to claim 11, wherein the device is releasably arranged on the frame.

13. The exercise device according to claim 10, wherein the device can be mounted on a crosspiece of the frame.

14. The exercise device according to claim 11, wherein the device is integrated in the frame.
